(19) United States
(12) Patent Application Publication
(10) Pub. No.: US 2014/0059618 A1
(43) Pub. Date: Feb. 27, 2014

(54) COMMUNICATION TRANSMISSION METHODS AND SYSTEMS

(71) Applicant: ACER INCORPORATED, New Taipei City (TW)

(72) Inventors: Hung-Yu WEI, New Taipei City (TW); Ching-Chun CHOU, New Taipei City (TW)

(73) Assignee: ACER INCORPORATED, New Taipei City (TW)

(21) Appl. No.: 13/845,979

(22) Filed: Mar. 18, 2013

Related U.S. Application Data
(60) Provisional application No. 61/692,435, filed on Aug. 23, 2012.

(51) Int. Cl. H04N 21/61

(52) U.S. Cl. CPC H04N 21/6131
USPC 725/62

(57) ABSTRACT

Communication transmission methods and systems are provided. Firstly, user equipment is configured to transmit a video service request. Then, a base station is configured to configure encoded data in each layer of SVC video data to different Multicast/Broadcast Single Frequency Networks for generating configuration information and broad the configuration information corresponding to each of the Multicast/Broadcast Single Frequency Networks to the user equipment according to the video service request.

### CROSS REFERENCE TO RELATED APPLICATIONS

This Application claims priority of U.S. Provisional Patent Application No. 61/692,435, filed on Aug. 23, 2012, the entirety of which is incorporated by reference herein.

### BACKGROUND OF THE INVENTION

1. Field of the Invention

The disclosure is related to communication transmission systems and methods and, more particularly, to systems and methods that can configure encoded data in each layer of scalable video coding (SVC) video data to different Multicast/Broadcast Single Frequency Networks (MBSFNs).

2. Description of the Related Art

Wireless communication systems are widely deployed to provide various telecommunication services such as telephony, video, data, messaging, and broadcast. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by the Third Generation Partnership Project (3GPP). It is designed to better support mobile broadband Internet access by improving spectral efficiency, lower costs, improve services, make use of new spectrums, and better integrate with other open standards using OFDMA on downlinks (DL), and SC-FDMA on uplinks (UL), and multiple-input multiple-output (MIMO) antenna technology.

Multimedia Broadcast Multicast Service (MBMS) and Enhanced MBMS (E-MBMS) mechanisms are defined in 3GPP standard to provide video services. Multicast-Broadcast Single Frequency Network (MBSFN) is used to provide wide-area mobile TV coverage through a single frequency network. On the other hand, scalable video coding (SVC) has shown a great potential for better video service delivery in a networked environment. MPEG-4/H.264 SVC has become a popular video coding standard. A traditional way of providing SVC video service over an LTE network is to transmit the SVC video stream over only one MBSFN. However, the traditional approach does not consider the diverse wireless environment. Mobile devices are non-uniformly distributed over the wireless system. In addition, mobile devices have diverse video viewing requirements (for example, different devices have different display size and display resolution. Different users might have different preferences on base layer video and enhanced video quality) and face different wireless transmission conditions.

### BRIEF SUMMARY OF THE INVENTION

Communication transmission systems and methods are provided to overcome the above mentioned problems.

An embodiment of the invention provides a communication transmission method, comprising: configuring, by a base station, encoded data in each layer of scalable video coding (SVC) video data to different Multicast/Broadcast Single Frequency Networks (MBSFNs) for generating configuration information; transmitting, by user equipment, a video service request and broadcasting, by the base station, the configuration information corresponding to each of the Multicast/Broadcast Single Frequency Networks to the user equipment according to the video service request.

An embodiment of the invention provides a communication transmission method for a base station, comprising: configuring encoded data in each layer of SVC video data to different Multicast/Broadcast Single Frequency Networks for generating configuration information; receiving a video service request from the user equipment; and broadcasting the configuration information corresponding to each of the Multicast/Broadcast Single Frequency Networks to the user equipment according to the video service request.

An embodiment of the invention provides a communication transmission method for a base station, comprising: configuring encoded data in each layer of SVC video data to different Multicast/Broadcast Single Frequency Networks for generating configuration information; and broadcasting the configuration information to user equipment, wherein the equipment will select the encoded data according to the configuration information.

An embodiment of the invention provides a communication transmission method for user equipment comprising: transmitting a video service request to a base station; and receiving configuration information from the base station according to the video service request, wherein the configuration information is related to encoded data in each layer of SVC video data to different Multicast/Broadcast Single Frequency Networks.

An embodiment of the invention provides a communication transmission method for user equipment comprising: receiving configuration information from the base station, wherein the configuration information is related to encoded data in each layer of SVC video data to different Multicast/Broadcast Single Frequency Networks; and selecting the encoded data according to the configuration information.

An embodiment of the invention provides a communication transmission system, comprising: user equipment, configured to transmit a video service request; and a base station, configured to configure encoded data in each layer of SVC video data to different Multicast/Broadcast Single Frequency Networks for generating configuration information and broadcast the configuration information corresponding to each of the Multicast/Broadcast Single Frequency Networks to the user equipment according to the video service request.

An embodiment of the invention provides a base station, comprising: a processing unit, configured to configure encoded data in each layer of SVC video data to different Multicast/Broadcast Single Frequency Networks for generating configuration information; a receiving unit, configured to receive a video service request from user equipment; and a broadcasting unit, configured to broadcast the configuration information corresponding to each of the Multicast/Broadcast Single Frequency Networks to the user equipment according to the video service request.

An embodiment of the invention provides a base station, comprising: a processing unit, configured to configure encoded data in each layer of SVC video data to different Multicast/Broadcast Single Frequency Networks for generating configuration information; and a broadcasting unit, configured to broadcast the configuration information to user equipment, wherein the equipment will select the encoded data according to the configuration information.

An embodiment of the invention provides user equipment comprising: a transmitting unit, configured to transmit a video service request to a base station; and a receiving unit, configured to receive configuration information from the base station according to the video service request, wherein the configuration information is related to encoded data in each layer of SVC video data to different Multicast/Broadcast Single Frequency Networks.

An embodiment of the invention provides user equipment comprising: a receiving unit, configured to receive configuration information from the base station, wherein the configuration information is related to encoded data in each layer of SVC video data to different Multicast/Broadcast Single Frequency Networks; and a selecting unit, configured to select the encoded data according to the configuration information.

Other aspects and features of the invention will become apparent to those with ordinary skill in the art upon review of the following descriptions of specific embodiments of communication transmission methods and systems.

### BRIEF DESCRIPTION OF THE DRAWINGS

The invention will become more fully understood by referring to the following detailed description with reference to the accompanying drawings, wherein:

FIG. 1 is schematic diagram illustrating a communication transmission system 100 according to an embodiment of the invention;

FIG. 2 is schematic diagram illustrating the base station 130 according to an embodiment of the invention;

FIG. 3 is schematic diagram illustrating the user equipment 110 according to an embodiment of the invention;

FIG. 4 is schematic diagram illustrating the different MBSFNs according to an embodiment of the invention;

FIGS. 5A-5I are schematic diagrams illustrating the configuration of the pointer in MBSFNs according to an embodiment of the invention;

FIG. 6 is a flowchart 600 of a communication transmission method according to an embodiment of the invention; and

FIG. 7 is a flowchart 700 of a communication transmission method for a base station according to an embodiment of the invention.

FIG. 8 is a flowchart 800 of a communication transmission method for a base station according to another embodiment of the invention.

FIG. 9 is a flowchart 900 of a communication transmission method for user equipment according to an embodiment of the invention.

FIG. 10 is a flowchart 1000 of a communication transmission method for user equipment according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

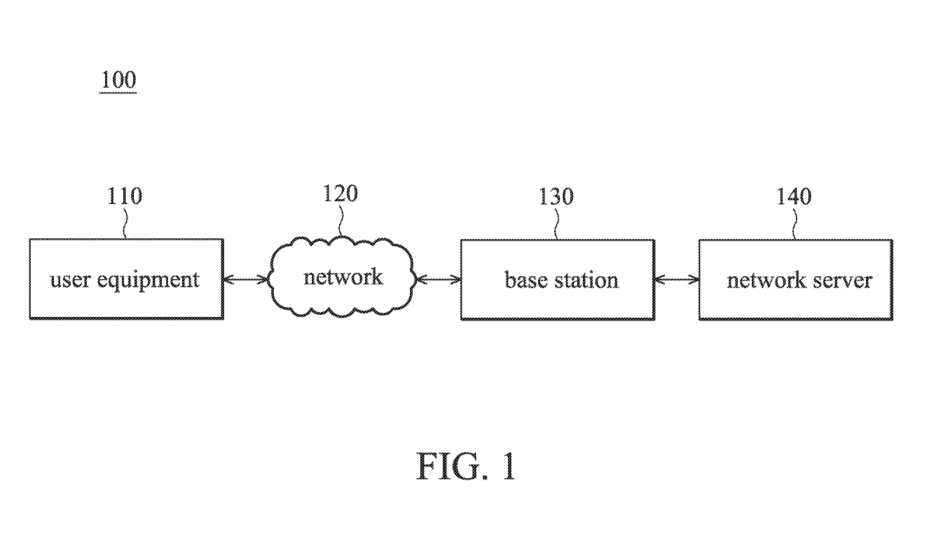

FIG. 1 is schematic diagram illustrating a communication transmission system 100 according to an embodiment of the invention. In this embodiment, the communication transmission system 100 comprises user equipment (UE) 110, a network 120, a base station 130, and a network server 140.

Various embodiments are described herein in connection with the user equipment 110. A wireless terminal can refer to a device providing voice and/or data connectivity to a user. The user equipment 110 can be connected to a computing device such as a laptop computer or desktop computer, or it can be a self contained device such as a personal digital assistant (PDA). The user equipment 110 can also be called a system, subscriber unit, subscriber station, mobile station, mobile, remote station, remote terminal, access terminal, user terminal, user agent, or user device. The user equipment 110 can be a subscriber station, wireless device, cellular telephone, PCS telephone, cordless telephone, Session Initiation Protocol (SIP) phone, wireless local loop (WLL) station, personal digital assistant (PDA), smart phone, tablet, mobile TV, handheld device having wireless connection capability, or another processing device connected to a wireless modem.

In one example, the first communication network 120 can operate according to various radio access technologies, such as, for example, 3GPP LTE, CDMA2000 (e.g., 1x Radio Transmission Technology (RTT), etc.), WiMax, Wireless Local Area Network (WLAN), Universal Mobile Telecommunications System (UMTS), or the like.

The base station 130 may be a fixed station or access network used for communicating with the terminals and may also be referred to as an access point, a Node B, an enhanced base station, an eNodeB (eNB), or some other terminology.

As shown in FIG. 1, the user equipment 110 is configured to transmit a video service request via the network 120. The base station 130 is configured to configure encoded data in each layer of scalable video coding (SVC) video data to different Multicast/Broadcast Single Frequency Networks (MBSFNs) for generating configuration information and notify the user equipment 110 of the configuration information corresponding to each of the MBSFNs according to the video service request, wherein the configuration information from the base station 130 would be recorded in the network server 140. In one embodiment of the invention, the video service request is related to the resolution of the user equipment 110. The resolution is dependant on the capability of the user equipment 110, for example, the user equipment 110 with larger screens needs large resolution. In one embodiment of the invention, the user equipment 110 might combine the video data from different Multicast/Broadcast Single Frequency Networks (MBSFNs) and display the combined video data.

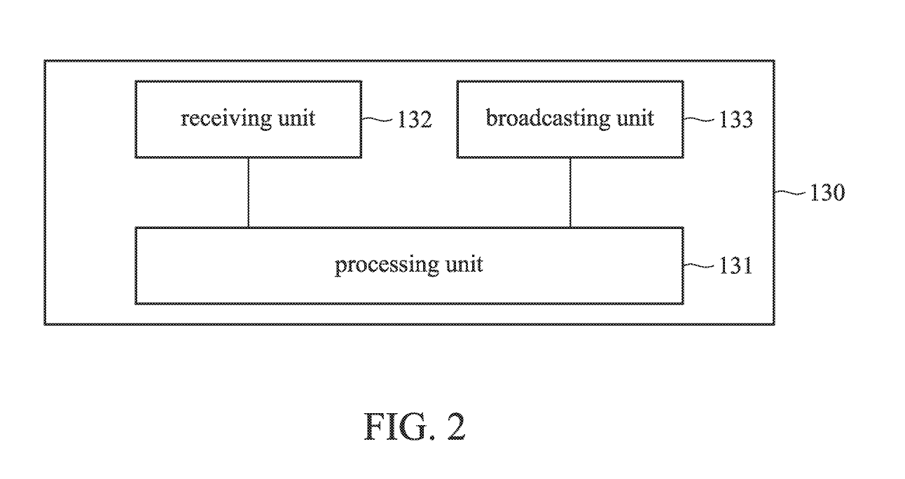

FIG. 2 is schematic diagram illustrating the base station 130 according to an embodiment of the invention. In FIG. 2 a base station 130 comprises a processing unit 131, a receiving unit 132 and a broadcasting unit 133. The processing unit 131 is configured to configure encoded data in each layer of SVC video data to different Multicast/Broadcast Single Frequency Networks for generating configuration information. The receiving unit 132 is configured to receive a video service request from user equipment 110. The broadcasting unit 133 is configured to broadcast the configuration information corresponding to each of the Multicast/Broadcast Single Frequency Networks to the user equipment 110 according to the video service request. In another embodiment of the invention, the broadcasting unit is configured to broadcast the configuration information to user equipment, wherein the equipment will select the encoded data according to the configuration information.

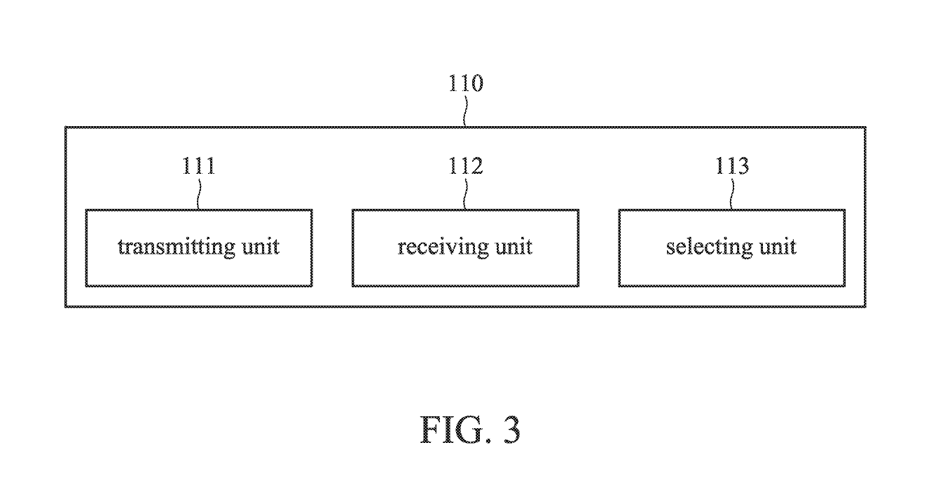

FIG. 3 is schematic diagram illustrating the user equipment according to an embodiment of the invention. In FIG. 3, user equipment 110 comprises a transmitting unit 111, a receiving unit 112, and a selecting unit 113. The transmitting unit 111 is configured to transmit a video service request to the base station 130, and the receiving unit 112 is configured to receive configuration information from the base station 130 according to the video service request, wherein the configuration information is related to encoded data in each layer of SVC video data to different Multicast/Broadcast Single Frequency Networks. In another embodiment of the invention, the base station 130 does not require the user equipment 110 to transmit a video service request, and the user equipment 110 may select the encoded data by the selecting unit 113 directly according to the configuration information.

In one embodiment of the invention, the network server 140 may be a network node to manage the Multimedia Broadcast Multicast Service (MBMS) radio resource configuration, such as Multi Media Extension (MME). In another embodiment of the invention, the network server 140 may be a network node to configure the MBMS session initialization and termination, such as a Mobile Switching Center (MSC). The configuration of multiple MBSFNs to support different layers of SVC video data can be stored in the network server 140 to manage MBMS radio resources.

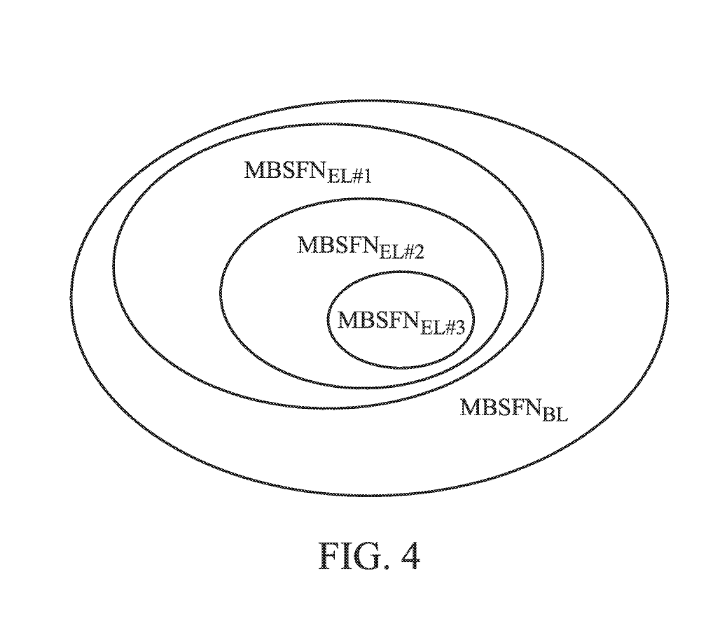

FIG. 4 is schematic diagram illustrating the different MBSFNs according to an embodiment of the invention. As shown in FIG. 4, the layers of the scalable video coding (SVC) video data comprise a base layer and three enhancement layers and each layer corresponds to the different MBSFN. For example, the MBSFN_{BL} corresponds to the base layer and is configured to provide the data in the base layer; the MBSFN_{EL#1} corresponds to the enhancement layer 1 and is configured to provide the data in the enhancement layer 1; the MBSFN_{EL#2} corresponds to the enhancement layer 2 and is configured to provide the data in the enhancement layer 2; the MBSFN_{EL#3} corresponds to the enhancement layer 3 and is configured to provide the data in the enhancement layer 3. In one embodiment of the invention, the different MBSFNs are provided the different resolutions of the different user equipment. For example, user equipment with small screens (such as mobile phone) only require low resolution, therefore the user equipment only requires the data in the base layer for decoding the scalable video coding (SVC) video data (i.e. user equipment only needs MBSFN_{BL}); and user equipment with large screens (such as Tablet PC) require high resolution, therefore the user equipment requires the data in the base layer and other data in enhancement layers for decoding the scalable video coding (SVC) video data (i.e. user equipment may need MBSFN_{BL}+MBSFN_{EL#1}+MBSFN_{EL#2}+MBSFN_{EL#3}). The example of FIG. 4 is for illustrative purposes and should not be used to limit the scope of the invention. Those who are skilled in this technology can make different numbers of MBSFNs according to the number of layers of the scalable video coding (SVC) video data. In addition, the embodiment only considers that the data in different layers is dependent, that is, if user equipment needs to decode the data from MBSFN_{EL#3}, the user equipment must also need the data from MBSFN_{BL}, MBSFN_{EL#1}, and MBSFN_{EL#2}. However this should not limit the invention, and those who are skilled in this technology can also use non-dependent data in different layers in the invention, that is, user equipment may only need the data from MBSFN_{BL} and MBSFN_{EL#3} to decode the video data.

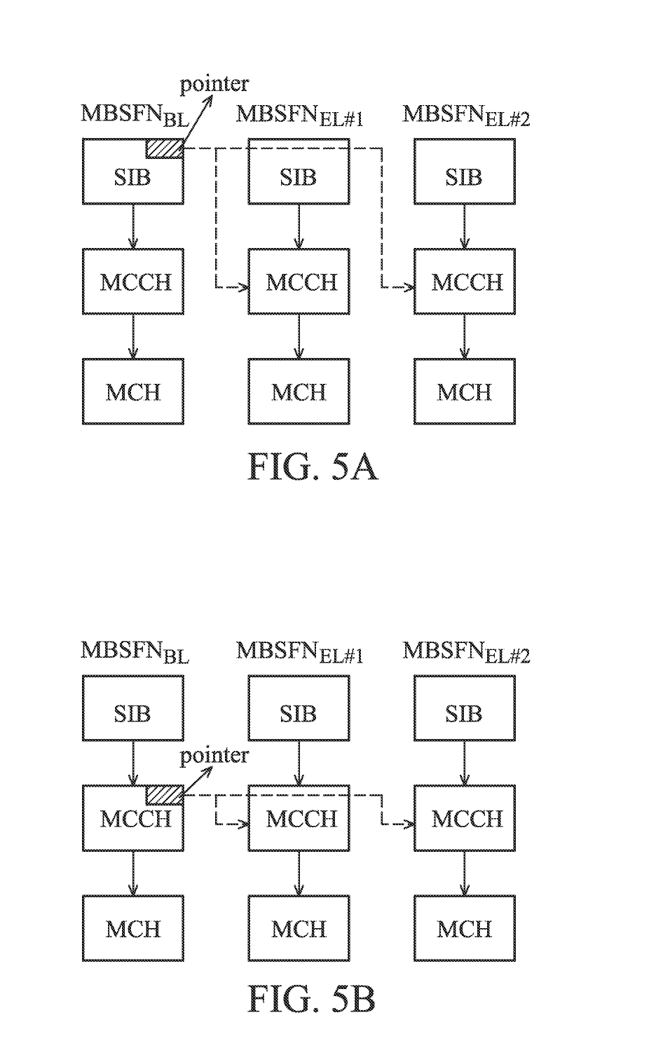

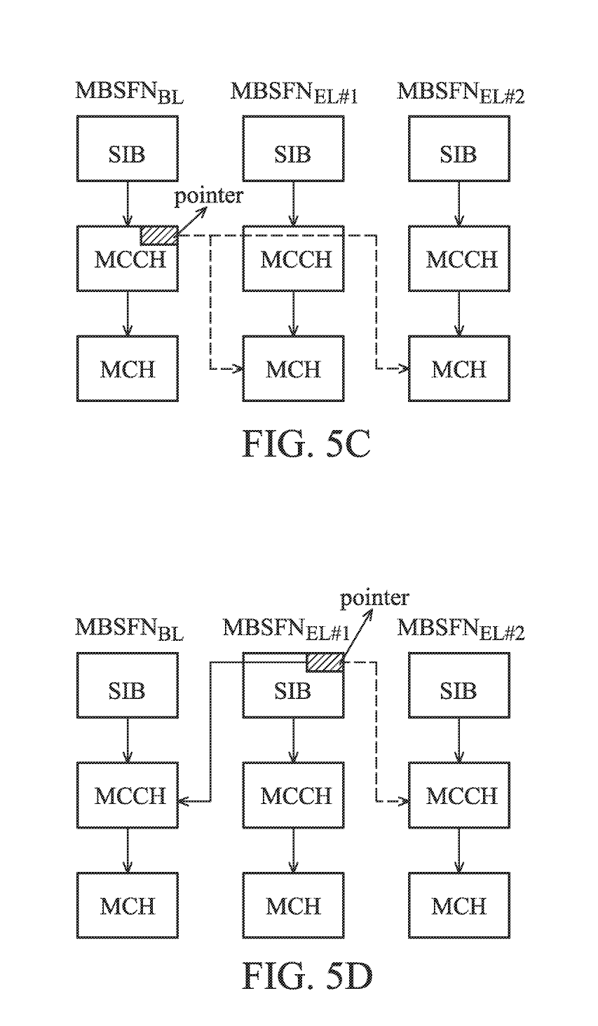

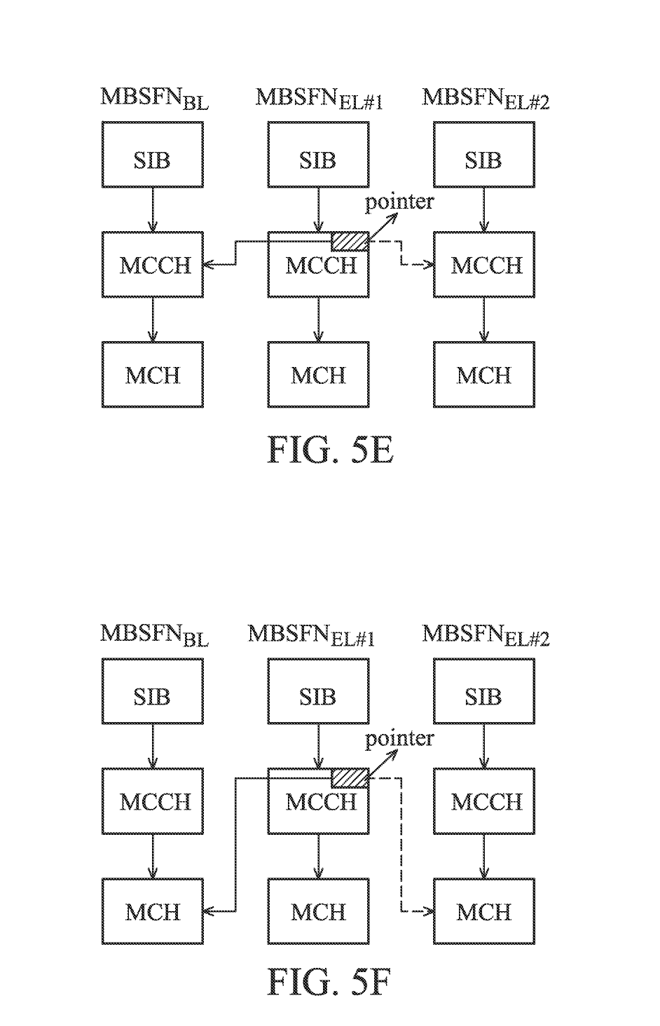

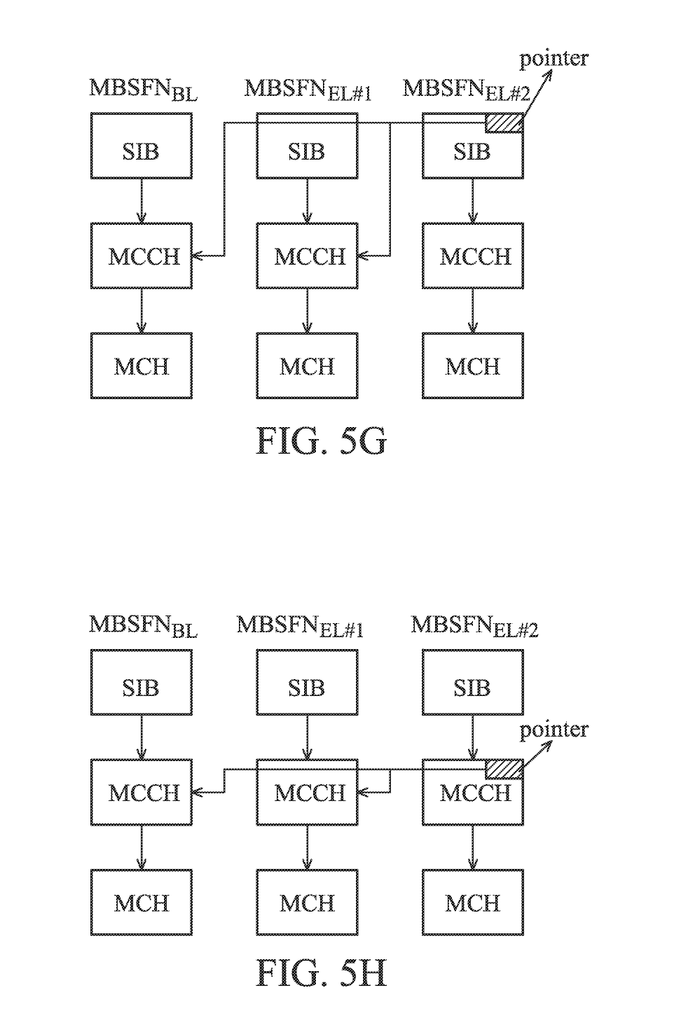

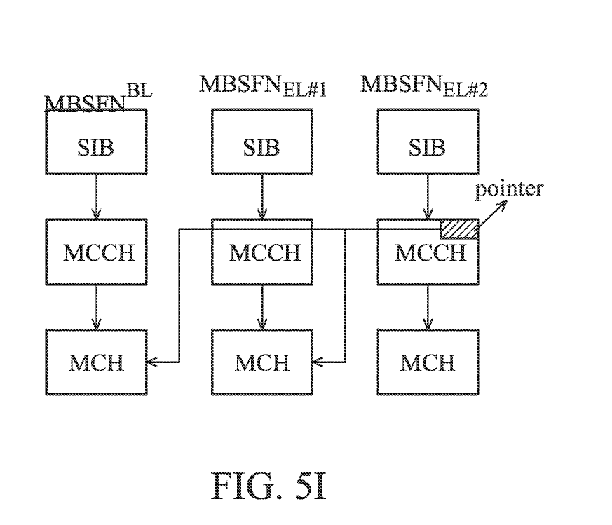

In one embodiment, the base station 130 notifies the configuration information corresponding to each of the MBSFNs to the user equipment by a pointer. FIGS. 5A-5I are schematic diagrams illustrating the configuration of the pointer in MBSFNs according to an embodiment of the invention. As shown in FIGS. 5A-5I, the pointer is configured in the system information block (SIB) of one of the MBSFNs or the Multicast Control Channel (MCCH) of one of the MBSFNs. More specifically, the dashed lines in FIGS. 3A-3I mean that “user equipment may achieve higher resolutions by this pointer” and the solid lines in FIGS. 5A-5I mean that “user equipment needs it to decode the video data”. In FIGS. 5A-5C, if the pointer is provided by MBSFN_{BL}, when the pointer is in the SIB, the pointer may point to the control channel (i.e. MCCH) of another MBSFN; and when the pointer is in the control channel, the pointer may point to the control channel (i.e. MCCH) of another MBSFN or the pointer may point to the data channel (i.e. MCH) of another MBSFN. In FIGS. 5D-5I, if the pointer is provided by MBSFN _{EL#X} (x=1 or 2), MBSFN _{EL#X} must provide the pointer to MBSFN _{EL#y} (y<x) and MBSFN_{BL}, that is, if the equipment wants to decode the data of MBSFN _{EL#2}, the equipment must also have the data in MBSFN_{BL} and MBSFN _{EL#1}. When the pointer is in the SIB, the pointer may point to the control channel (i.e. MCCH) of another MBSFN; and when the pointer is in the control channel, the pointer may point to the control channel (i.e. MCCH) of another MBSFN or the pointer may point to the data channel (i.e. MCH) of another MBSFN.

In one embodiment, each of the MBSFNs has a different coding (e.g. fountain code, rateless code, network coding, etc) with a different reliability wherein coding is used to protect the contents of distinct MBSFNs. In addition, different MBSFNs have different levels of protection, that is, a different number of redundancies are provided for different SVC layers. For example, as shown in FIG. 4, MBSFN_{BL} may be provided using fountain codes with high reliability and many redundancies are provided to ensure the decoding of the base layer. In addition, MBSFN_{EL#X} (x=1˜3) may be provided using fountain codes with lower reliability and the number of redundancies for different MBSFNs and the corresponding SVC layers may be arbitrary, inversely proportional to x, or the same number of redundancies for every layer.

In one embodiment, coverage of the MBSFNs can be configured dynamically. For example, the data in an enhancement layer is only provided to the users who require the higher resolution videos in cells, therefore, the coverage of the MBSFN_{EL} can expand or diminish according to the requirement of higher resolution videos in cells.

In one embodiment, different MBSFNs may provide different Temporal Scalability (TS) for SVC video data, wherein TS means that the video's frame rate varies along with time and the specific frame rate is provided for each TS. User equipment may achieve a higher overall frame rate if they receive the signals from different MBSFNs.

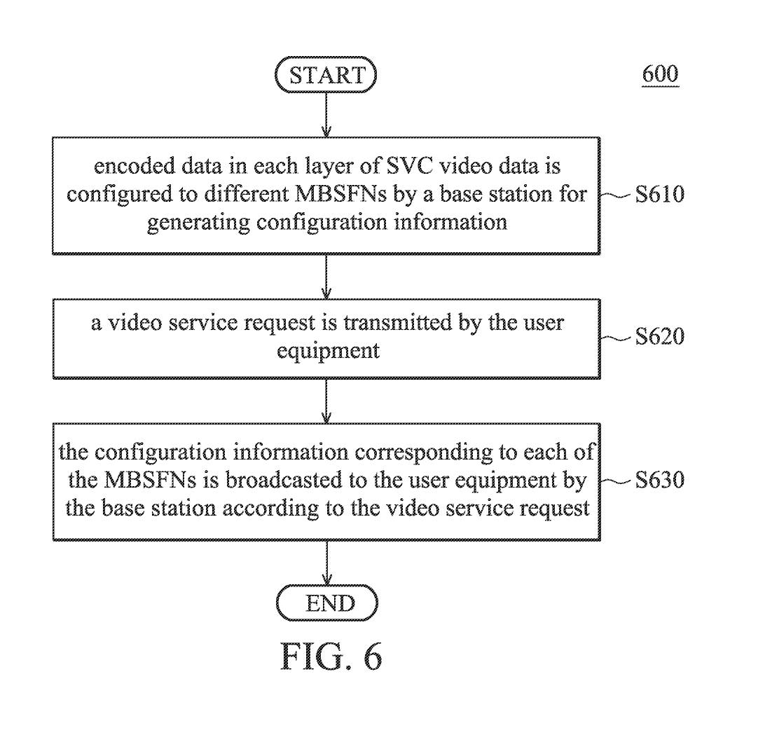

FIG. 6 is a flowchart 600 of a communication transmission method according to an embodiment of the invention. According to the embodiment, the communication transmission method is configured to be applied in user equipment such as a computer and portable device such as a tablet computer, Personal Digital Assistant (PDA), smartphone, mobile phone, mobile internet device, or notebook. Firstly, in step S610, encoded data in each layer of SVC video data is configured to different MBSFNs by a base station for generating configuration information. Then, in step S620, a video service request is transmitted by the user equipment. In step S630, the configuration information corresponding to each of the MBSFNs is broadcasted to the user equipment by the base station according to the video service request. In one embodiment, the layers of the SVC video data comprise a base layer and one or more enhancement layers, wherein each layer corresponds to the different MBSFN.

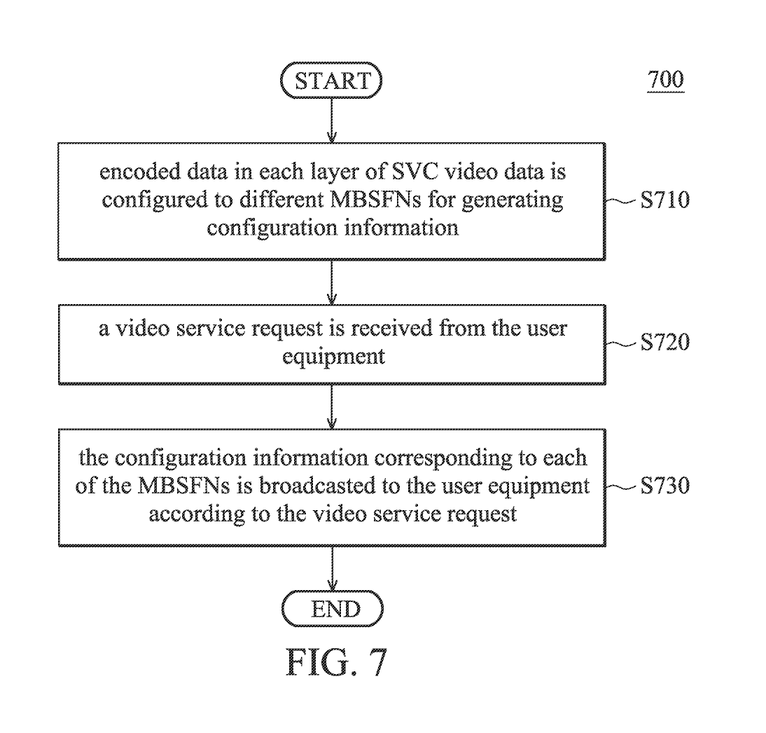

FIG. 7 is a flowchart 700 of a communication transmission method for a base station according to an embodiment of the invention. Firstly, in step S710, encoded data in each layer of SVC video data is configured to different MBSFNs for generating configuration information. Then, in step S720, a video service request is received from the user equipment. In step S730, the configuration information corresponding to each of the MBSFNs is broadcasted to the user equipment according to the video service request. In one embodiment, the layers of the SVC video data comprise a base layer and one or more enhancement layers, wherein each layer corresponds to a different MBSFN.

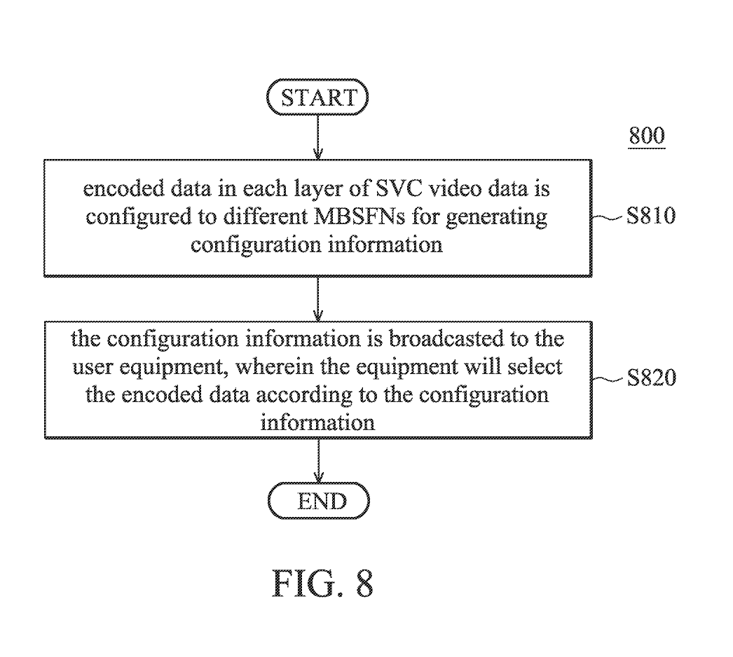

FIG. 8 is a flowchart 800 of a communication transmission method for a base station according to another embodiment of the invention. Firstly, in step S810, encoded data in each layer of SVC video data is configured to different MBSFNs for generating configuration information. Then, in step S820, the configuration information is broadcasted to the user equipment, wherein the equipment will select the encoded data according to the configuration information. In one embodiment, the layers of the SVC video data comprise a base layer and one or more enhancement layers, wherein each layer corresponds to a different MBSFN.

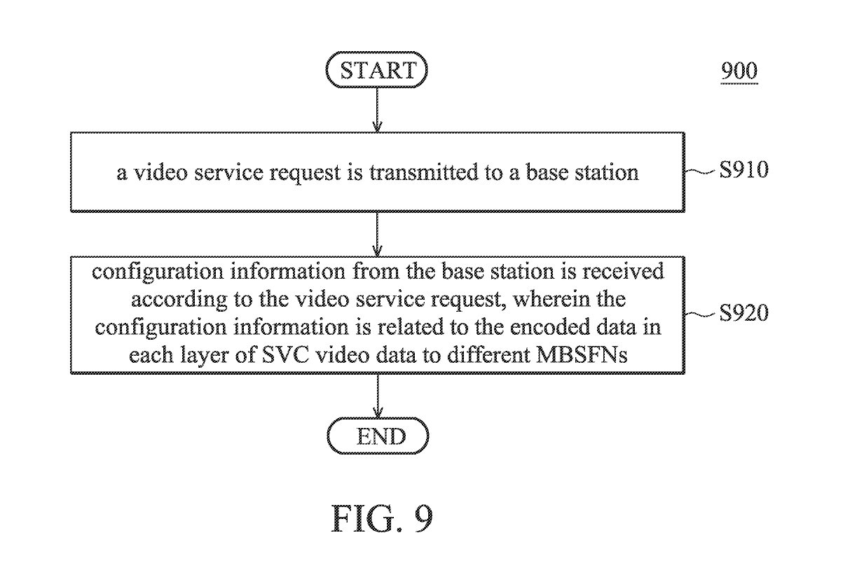

FIG. 9 is a flowchart 900 of a communication transmission method for user equipment according to an embodiment of the invention. Firstly, in step S910, a video service request is transmitted to a base station. In step S920, configuration information from the base station is received according to the video service request, wherein the configuration information is related to the encoded data in each layer of SVC video data to different MBSFNs. In one embodiment, the layers of the SVC video data comprise a base layer and one or more enhancement layers, wherein each layer corresponds to the different MBSFN.

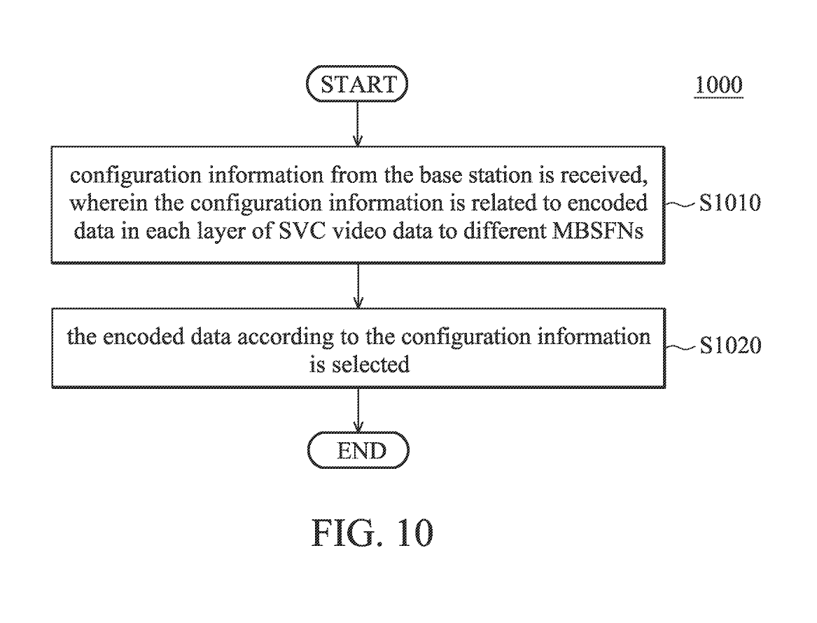

FIG. 10 is a flowchart 1000 of a communication transmission method for user equipment according to another embodiment of the invention. Firstly, in step 51010, configuration information from the base station is received, wherein the configuration information is related to encoded data in each layer of SVC video data to different MBSFNs. In step 51020, the encoded data according to the configuration information is selected. In one embodiment, the layers of the SVC video data comprise a base layer and one or more enhancement layers, wherein each layer corresponds to the different MBSFN.

Therefore, in the method of the communication transmission described in connection with the aspects disclosed herein, multiple MBSFNs are applied to deliver different video layers for SVC video streams. In this way, the video delivery quality can be enhanced and the radio resource utilization can be more efficient. In addition, the method considers that different users have different requests for base layer video and enhanced layer video quality, therefore multiple MBSFNs can provide different video layers for SVC video streams to the user equipment according to the request of the user. In this way, the method can save bandwidth resources in data transmission.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects of the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communication transmission method, comprising:
configuring, by a base station, encoded data in each layer of scalable video coding (SVC) video data to different Multicast/Broadcast Single Frequency Networks (MBSFNs) for generating configuration information;
transmitting, by user equipment, a video service request and
broadcasting, by the base station, the configuration information corresponding to each of the Multicast/Broadcast Single Frequency Networks to the user equipment according to the video service request.

2. The communication transmission method of claim 1, wherein the layers of the SVC video data comprise a base layer and one or more enhancement layers, wherein each layer corresponds to the different Multicast/Broadcast Single Frequency Network.

3. The communication transmission method of claim 1, wherein the base station notifies the configuration information corresponding to each of the Multicast/Broadcast Single Frequency Networks to the user equipment by a pointer.

4. The communication transmission method of claim 3, wherein the pointer is configured in a system information block (SIB) of one of the Multicast/Broadcast Single Frequency Networks or a Multicast Control Channel (MCCH) of one of the Multicast/Broadcast Single Frequency Networks.

5. The communication transmission method of claim 1, further comprising:
recording, by a network server, the configuration information from the base station.

6. The communication transmission method of claim 1, wherein each of the MBSFNs has a different fountain code with different reliability.

7. The communication transmission method of claim 1, wherein coverage of the Multicast/Broadcast Single Frequency Networks are configured dynamically.

8. A communication transmission method for a base station, comprising:
configuring encoded data in each layer of SVC video data to different Multicast/Broadcast Single Frequency Networks for generating configuration information;
receiving a video service request from user equipment; and
broadcasting the configuration information corresponding to each of the Multicast/Broadcast Single Frequency Networks to the user equipment according to the video service request.

9. The communication transmission method of claim 8, wherein the layers of the SVC video data comprise a base layer and one or more enhancement layers, wherein each layer corresponds to the different Multicast/Broadcast Single Frequency Network.

10. A communication transmission method for a base station, comprising:
configuring encoded data in each layer of SVC video data to different Multicast/Broadcast Single Frequency Networks for generating configuration information; and
broadcasting the configuration information to user equipment, wherein the encoded data is further selected by the user equipment according to the configuration information.

11. The communication transmission method of claim 10, wherein the layers of the SVC video data comprise a base layer and one or more enhancement layers, wherein each layer corresponds to the different Multicast/Broadcast Single Frequency Network.

12. A communication transmission method for user equipment comprising:
transmitting a video service request to a base station; and
receiving configuration information from the base station according to the video service request, wherein the configuration information is related to encoded data in each layer of SVC video data to different Multicast/Broadcast Single Frequency Networks.

13. The communication transmission method of claim 12, wherein the layers of the SVC video data comprise a base layer and one or more enhancement layers, wherein each layer corresponds to the different Multicast/Broadcast Single Frequency Network.

14. A communication transmission method for user equipment comprising:
receiving configuration information from the base station, wherein the configuration information is related to encoded data in each layer of SVC video data to different Multicast/Broadcast Single Frequency Networks; and
selecting the encoded data according to the configuration information.

15. The communication transmission method of claim 13, wherein the layers of the SVC video data comprise a base layer and one or more enhancement layers, wherein each layer corresponds to the different Multicast/Broadcast Single Frequency Network.

16. A communication transmission system, comprising:
user equipment, configured to transmit a video service request; and
a base station, configured to configure encoded data in each layer of SVC video data to different Multicast/Broadcast Single Frequency Networks for generating configuration information and notify the user equipment of the configuration information corresponding to each of the Multicast/Broadcast Single Frequency Networks according to the video service request.

17. The communication transmission system of claim 16, wherein the layers of the SVC video data comprise a base layer and one or more enhancement layers, wherein each layer corresponds to the different Multicast/Broadcast Single Frequency Network.

18. The communication transmission system of claim 16, wherein the base station notifies the configuration information corresponding to each of the Multicast/Broadcast Single Frequency Networks to the user equipment by a pointer.

19. The communication transmission system of claim 18, wherein the pointer is configured in a system information block of one of the Multicast/Broadcast Single Frequency Networks or a Multicast Control Channel of one of the Multicast/Broadcast Single Frequency Networks.

20. The communication transmission system of claim 16, further comprising:
a network server, configured to record the configuration information from the base station.

21. The communication transmission system of claim 16, wherein each of the Multicast/Broadcast Single Frequency Networks has a different fountain code with a different reliability.

22. The communication transmission system of claim 16, wherein coverage of the Multicast/Broadcast Single Frequency Networks are configured dynamically.

23. A base station, comprising:
a processing unit, configured to configure encoded data in each layer of SVC video data to different Multicast/Broadcast Single Frequency Networks for generating configuration information;
a receiving unit, configured to receive a video service request from user equipment; and
a broadcasting unit, configured to notify the user equipment of the configuration information corresponding to each of the Multicast/Broadcast Single Frequency Networks according to the video service request.

24. The base station of claim 23, wherein the layers of the SVC video data comprise a base layer and one or more enhancement layers, wherein each layer corresponds to the different Multicast/Broadcast Single Frequency Network.

25. A base station, comprising:
a processing unit, configured to configure encoded data in each layer of SVC video data to different Multicast/Broadcast Single Frequency Networks for generating configuration information; and
a broadcasting unit, configured to broadcast the configuration information to user equipment, wherein the equipment will select the encoded data according to the configuration information.

26. The base station of claim 25, wherein the layers of the SVC video data comprise a base layer and one or more enhancement layers, wherein each layer corresponds to the different Multicast/Broadcast Single Frequency Network.

27. User equipment comprising:
a transmitting unit, configured to transmit a video service request to a base station; and
a receiving unit, configured to receive configuration information from the base station according to the video service request, wherein the configuration information is related to encoded data in each layer of SVC video data to different Multicast/Broadcast Single Frequency Networks.

28. The user equipment of claim 27, wherein the layers of the SVC video data comprise a base layer and one or more enhancement layers, wherein each layer corresponds to the different Multicast/Broadcast Single Frequency Network.

29. User equipment comprising:
a receiving unit, configured to receive configuration information from the base station, wherein the configuration information is related to encoded data in each layer of SVC video data to different Multicast/Broadcast Single Frequency Networks; and
a selecting unit, configured to select the encoded data according to the configuration information.

30. The user equipment of claim 29, wherein the layers of the SVC video data comprise a base layer and one or more enhancement layers, wherein each layer corresponds to the different Multicast/Broadcast Single Frequency Network.
